(19) United States
(12) Patent Application Publication
(10) Pub. No.: US 2025/0194774 A1
(43) Pub. Date: Jun. 19, 2025

(54) DEVICE FOR STORING AND APPLYING MATERIAL TO SKIN OF A USER FOR MEDICAL AND COSMETIC PURPOSES

(71) Applicant: Nicholas Dymond Militello, Crystal Lake, IL (US)

(72) Inventor: Nicholas Dymond Militello, Crystal Lake, IL (US)

(21) Appl. No.: 18/983,756

(22) Filed: Dec. 17, 2024

Related U.S. Application Data
(60) Provisional application No. 63/612,161, filed on Dec. 19, 2023.
(60) Provisional application No. 63/649,398, filed on May 19, 2024.

(51) Int. Cl. A45D 34/04; A45D 40/26

(52) U.S. Cl. CPC A45D 34/043; A45D 40/264

(57) ABSTRACT

A device for storing and applying material to a skin of a user for medical and/or cosmetic purposes. The device comprising: a body including first and second sides that define (1) a cavity that functions as a reservoir for storing the material and (2) a hole that communicates with the cavity; and an applicator configured to be inserted into and removed from the hole of the body, the applicator including: (1) a first section configured to be grasped by the user for applicator removal from and insertion into the hole of the body; and (2) a second section for accumulating material within the cavity of the body and for subsequently applying the material to the skin of the user.

### CROSS-REFERENCE TO RELATED APPLICATIONS

This application claims priority to U.S. provisional application No. 63/612,161 filed on Dec. 19, 2023 entitled “Novel Hollow Container That Can Fit in A Card-Carring Device and Can Store, Reseal, and Apply Contents Repetitively” and U.S. provisional application No. 63/649,398, filed May 19, 2024 entitled “Novel Hollow Container That Can Fit in A Card-Carrying Device and Can Store, Reseal, and Apply Contents Repetitively” both of which are incorporated by reference herein.

### FIELD OF THE INVENTION

The present invention relates to a device for storing and applying material to the skin of a user for medical and/or cosmetic purposes.

### BACKGROUND OF THE INVENTION

Individuals experience many skin conditions throughout their lives. One common condition is dry or chapped lips. These conditions are typically due to dry and/or cold environmental factors. However, these skin conditions can be a side effect of medication such as Accutane. To address dry or chapped lips, the cosmetic and health industries have marketed several portable products such as stick tubes or small plastic containers that store material such as lip balm or petroleum jelly (by Vaseline for example). The user merely removes a top or unscrews a cap to expose the material and applies it to a user's lips using the stick or a user's finger. While these portable products are adequate for their intended purpose, some are cumbersome to carry, easily misplaced and often forgotten.

It would thus be advantageous to provide improvements these products.

### SUMMARY OF THE INVENTION

A device for storing and applying material to a skin of a user for medical and/or cosmetic purposes.

In accordance with an embodiment of the present disclosure, a device for storing and applying material to a skin of a user for medical and/or cosmetic purposes, the device comprising: a body including first and second sides that define (1) a cavity that functions as a reservoir for storing the material and (2) a hole that communicates with the cavity; and an applicator configured to be inserted into and removed from the hole of the body, the applicator including: (1) a first section configured to be grasped by the user for applicator removal from and insertion into the hole of the body; and (2) a second section for accumulating material within the cavity of the body and for subsequently applying the material to the skin of the user.

In accordance with an embodiment of the present disclosure, a device for storing and applying material to a skin of a user for medical and/or cosmetic purposes, the device configured to fit in a sleeve sized for a credit card, the device comprising: a body including first and second sides that define (1) a cavity that functions as a reservoir for storing the material, (2) a hole that communicates with the cavity and (3) a first indentation within the hole of the body; and an applicator configured to be inserted into and removed from the hole of the body, the applicator including: (1) a proximal section configured to be grasped by the user for applicator removal from and insertion into the hole of the body; (2) a distal section for accumulating material within the cavity of the body and for subsequently applying the material to the skin of the user; and (3) a mid-section between the proximal section and distal section having a first ridge that extends outwardly and that is configured to fit within the first indentation to secure the applicator within the body when seated therein.

In accordance with another embodiment of the present disclosure, a device for storing and applying material to a skin of a user for medical and/or cosmetic purposes, the device configured to fit in a sleeve sized for a credit card, the device comprising: a body including first and second sides that define (1) a cavity that functions as a reservoir for storing the material and (2) a hole that communicates with the cavity, the body including a first indentation within the hole of the body; and an applicator configured to be inserted into and removed from the hole of the body, the applicator including: (a) a first ridge that extends outwardly configured to fit within the indentation within the hole of the body and secure the applicator within the body when fully seated therein; (b) a tongue for accumulating material within the cavity of the body and for subsequently applying the material to the skin of the user.

### BRIEF DESCRIPTION OF DRAWINGS

FIG. 1 depicts a perspective view of an example device for storing and applying material to the skin of a user for medical and/or cosmetic purposes, with an applicator in an inserted configuration.

FIG. 2 depicts a plan view of the device in FIG. 1.

FIG. 3 depicts a side view of the device in FIG. 1

FIG. 4 depicts top view of the device in FIG. 1.

FIG. 5 depicts bottom view of the device in FIG. 1.

FIG. 6 depicts a plan view of the device in FIG. 1 taken along line 6-6 in FIG. 3.

FIG. 7 depicts a side view of the device in FIG. 1 taken along line 7-7 in FIG. 2.

FIG. 8 depicts a view of the device in FIG. 1 taken along line 8-8 in FIG. 2.

FIG. 9 depicts a an enlarged partial cross-sectional view of the device in FIG. 1 taken along circular line 9 in FIG. 7.

FIG. 10 plan view of the device in FIG. 1, without an applicator installed in a body of the device.

FIG. 11 depicts a side cross-sectional view of the device in FIG. 1 taken along line 11-11 in FIG. 10.

FIG. 12 depicts a side cross-sectional view of the device in FIG. 1 taken along line 12-12 in FIG. 10.

FIG. 13 depicts an enlarged partial cross-sectional view of the device in FIG. 1 taken along circular line 13 in FIG. 11.

FIG. 14 exploded cross-sectional view of the device in FIG. 1 in an exploded configuration, wherein the applicator is removed from the body of the device.

FIG. 15 is a front plan view of the applicator in FIG. 1.

FIG. 16 is a side view of the applicator in FIG. 1.

FIG. 17 is an enlarged partial side view of the applicator in FIG. 1 taken along circular line 17 in FIG. 16.

FIG. 18 is a side cross-sectional view of the applicator of FIG. 1 taken along 18 in FIG. 15.

FIG. 19 is an enlarged partial side cross-section view of the applicator in FIG. 1 taken along circular line 19 in FIG. 18.

FIG. 20 depicts a front cross-sectional view of a second example device for storing and applying material to a skin of a user for medical and/or cosmetic purposes in an exploded configuration.

FIG. 21 depicts a cross-sectional side view of the example device in FIG. 20 (as assembled).

FIG. 22 depicts an enlarged partial cross-sectional view of the example device in FIG. 20 along circular line 22 in FIG. 21.

FIG. 23 depicts an enlarged partial cross-sectional view of the example device in FIG. 20 along circular line 23 in FIG. 20.

FIG. 24 depicts a plan view of the applicator in FIG. 20.

FIG. 25 depicts a cross-sectional view of the applicator in FIG. 24 along line 25-25.

FIG. 26 depicts an enlarged partial cross-sectional view of the applicator in FIG. 24 along circular line 26 in FIG. 25

FIG. 27 depicts a plan view of a third example device for storing and applying material to a skin of a user for medical and/or cosmetic purposes.

FIG. 28 depicts a side view of the device in FIG. 27.

FIG. 29 depicts a cross-sectional view of the device in FIG. 27 along the line 29-29.

FIG. 30 depicts a plan view of the applicator in the device in FIG. 27.

FIGS. 31 and 32 depict top and bottom views of the applicator in FIG. 30.

FIG. 33 depicts a side view of the applicator in FIG. 30.

FIG. 34 depicts a perspective view of a fourth example device for storing and applying material to a skin of a user for medical and/or cosmetic purposes.

FIG. 35 depicts a plan view of the example device in FIG. 34.

FIG. 36 depicts a side view of the device in FIG. 34.

FIGS. 37 and 38 depict a top view and bottom view of the device in FIG. 34.

FIG. 39 depicts a cross-sectional view of the device in FIG. 34 along the line 39-39 in FIG. 36.

FIG. 40 depicts a cross-sectional view of the device in FIG. 34 along line 40-40 in FIG. 35.

FIG. 41 depicts a cross-sectional view of the device in FIG. 34 along line 41-41 in FIG. 35.

FIG. 42 depicts a plan view of a fifth example device for storing and applying material to a skin of a user for medical and/or cosmetic purposes.

FIG. 43 depicts a side view of the device in FIG. 42.

FIG. 44 depicts a cross-sectional view of the device with applicator removed from the body in FIG. 42.

FIG. 45 depicts a top view of the device in FIG. 42 with the applicator removed from the body.

FIG. 46 depicts a cross-sectional view of the device in FIG. 42 along the line 46-46 in FIG. 43.

FIG. 47 depicts an enlarged partial cross-sectional view of the device in FIG. 42 along circular line 47 in FIG. 46.

FIG. 48 depicts an enlarged partial cross-sectional view of the device in FIG. 42 along circular line 48 in FIG. 45.

FIG. 49 depicts an enlarged partial cross-sectional view of the device in FIG. 42 along circular line 49 in FIG. 44.

FIG. 50 depicts a plan view of a sixth example device for storing and applying material to a skin of a user for medical and/or cosmetic purposes.

FIG. 51 depicts a side view of the device in FIG. 50.

FIG. 52 depicts a top view of the device in FIG. 50.

FIG. 53 depicts a cross-sectional view of the device in FIG. 50 along line 53-53 in FIG. 50.

FIG. 54 depicts a cross-sectional view of the device in FIG. 50 along the line 54-54 in FIG. 51.

FIG. 55 depicts a perspective view of a seventh example device for storing and applying material to a skin of a user for medical and/or cosmetic purposes.

FIG. 56 depicts a plan view of the device in FIG. 55.

FIG. 57 depicts a side view of the device in FIG. 55.

FIG. 58 depicts a top view of the device in FIG. 55.

FIG. 59 depicts bottom view of the device in FIG. 55.

FIG. 60 depicts a cross-sectional view of the device in FIG. 55 along line 60-60 in FIG. 56.

FIG. 61 depicts a cross-sectional view of the device in FIG. 55 along line 61-61 in FIG. 56.

FIG. 62 depicts a cross-sectional view of the device in FIG. 55 along line 62-62 in FIG. 57.

FIG. 63 depicts a perspective view of the example device in FIG. 1 in a practical application.

FIG. 64 depicts a perspective view of the example device in FIG. 1 in another practical application.

### DETAILED DESCRIPTION OF THE INVENTION

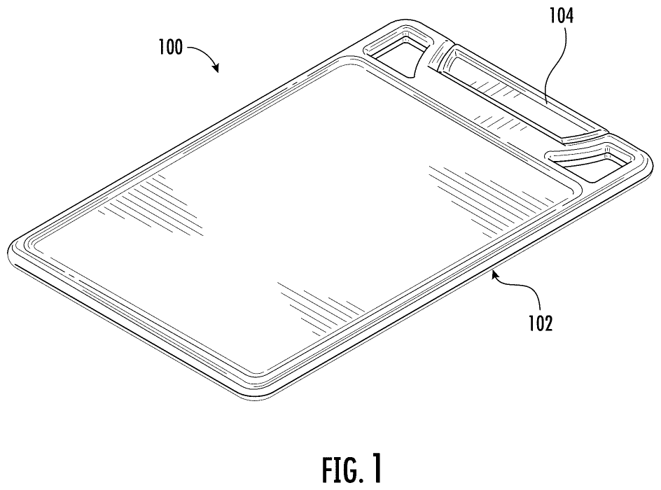

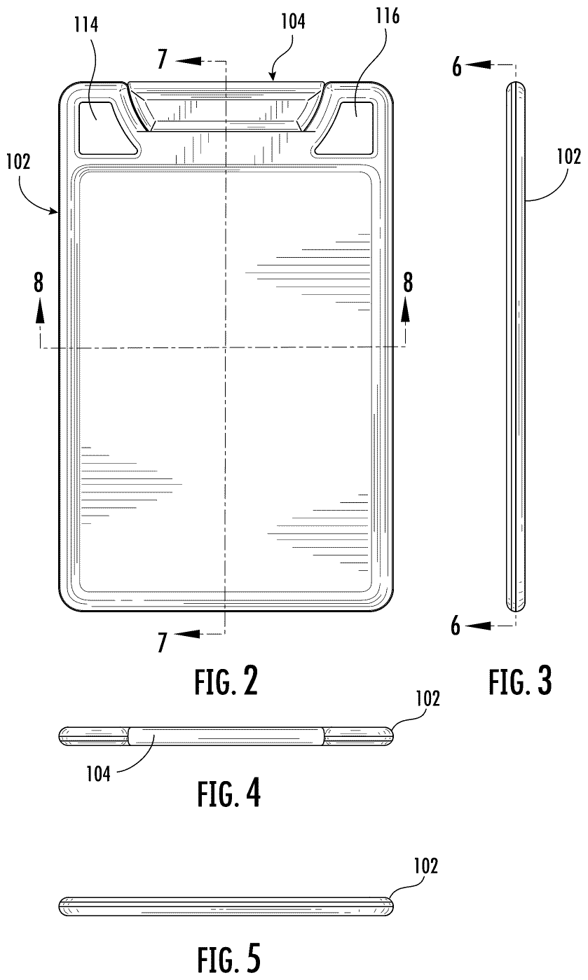

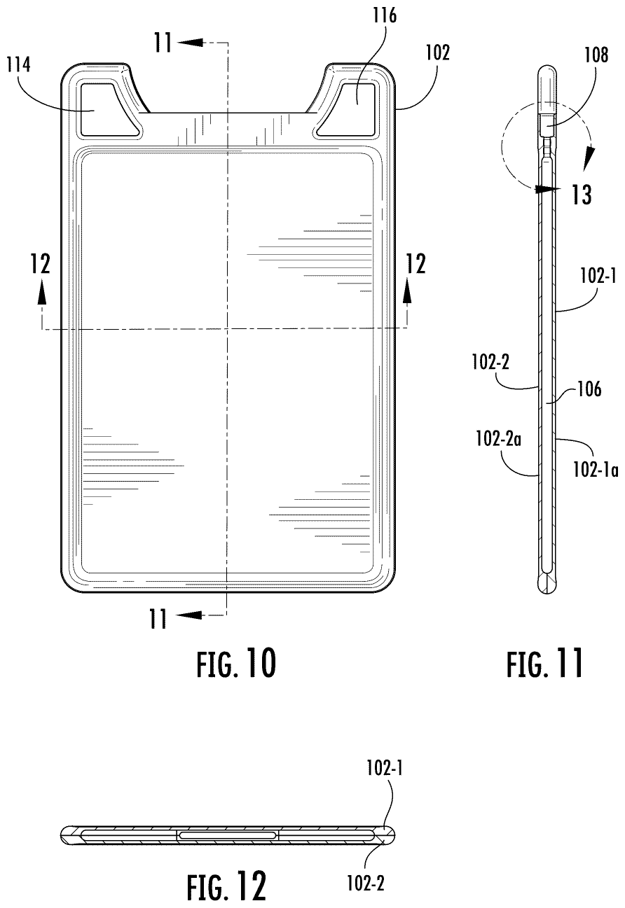

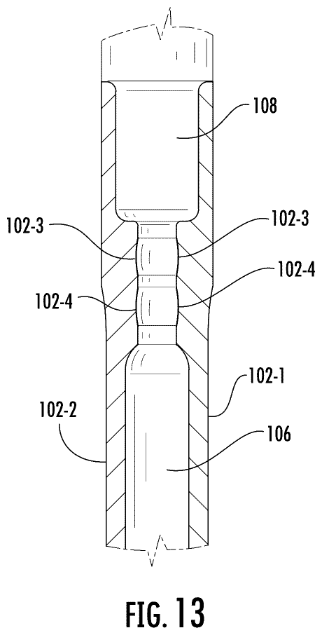

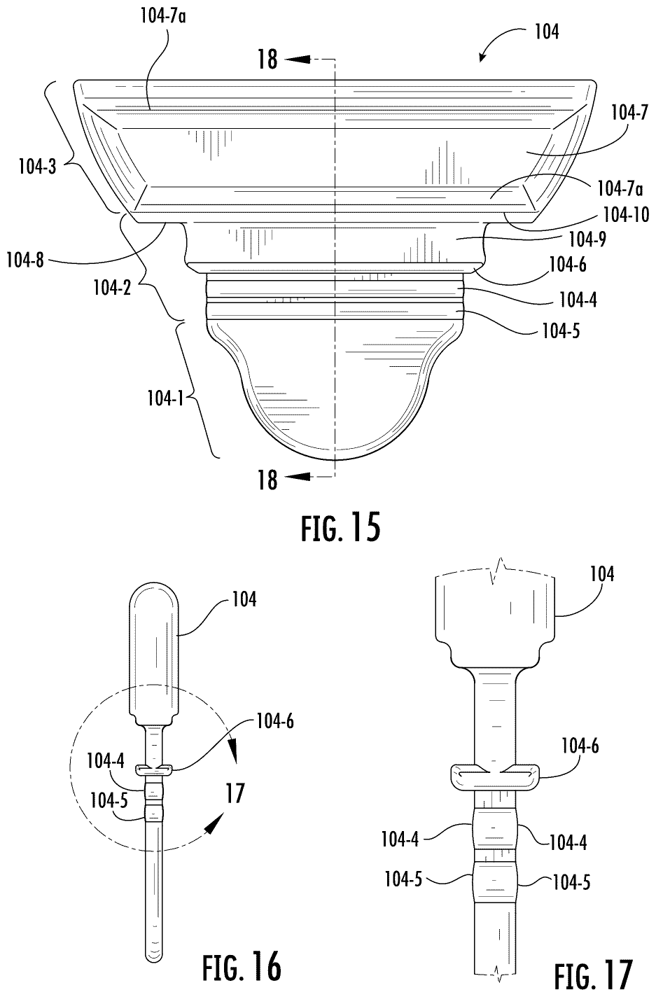

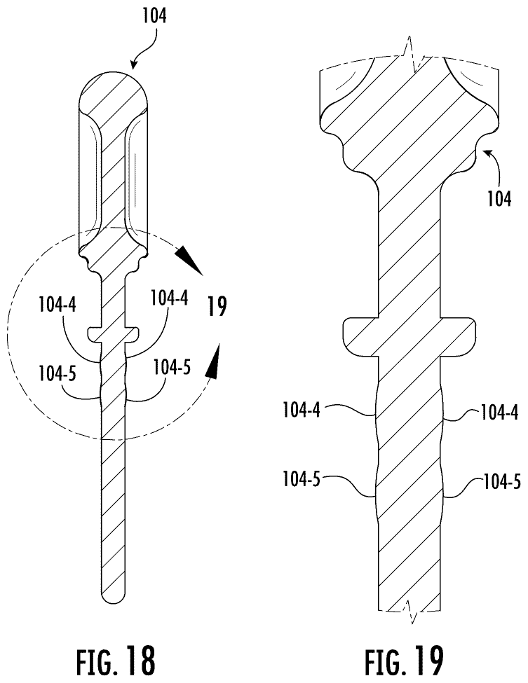

FIG. 1 depicts a perspective view of an example device 100 for storing and applying material to a skin of a user for medical and/or cosmetic purposes. FIGS. 2-19 depict device 100 and/or applicator 104 in FIG. 1 in various views and configurations. Example device 100 is typically used to apply material to the epidermis layer of a user's skin. A user will likely apply the material to a user's lips. The material may be lip balm, lip gloss, petroleum jelly, ointment or any other material for medical and/or cosmetic purposes known to those skilled in the art. The device 100 includes housing or body 102 and a cap or applicator 104 that is shown inserted into body 102 as described in more detail below. In this example, device 100 is designed to fit within a sleeve of a wallet, purse or mobile device attachment that is designed for a credit card or other small items such as currency. (That is, device 100 is intended to be portable, i.e., convenient to carry.) However, device 100 may be sized to fit in any form size to achieve desired results as known to those skilled in the art.

Body 102 is configured as a container that functions to store the contents or material inside cavity 106 of body 102. Cavity 106 functions as a reservoir for the material and hole 108 is used to fill cavity 106 and receive and seat applicator 104. Body 102 may be configured as a single integral structure with two sides (or walls) that define a cavity and a hole. Body 102 may also be configured as a two-piece (or multi-piece) structure, i.e., two separate sides (walls) that are combined or joined together to form body 102. In this example in FIGS. 1-19, a two-piece structure is employed as two separately constructed sides 102-1 and 102-2. The sides are combined or joined together to form body 102. Specifically, body 102 includes sides 102-1 and 102-2 that are joined together to define cavity 106 and hole 108 that communicates with cavity 106. (Hole 108 may be referred to as a channel with an opening.) As described herein, hole 108 is configured to receive material and seat applicator 104.

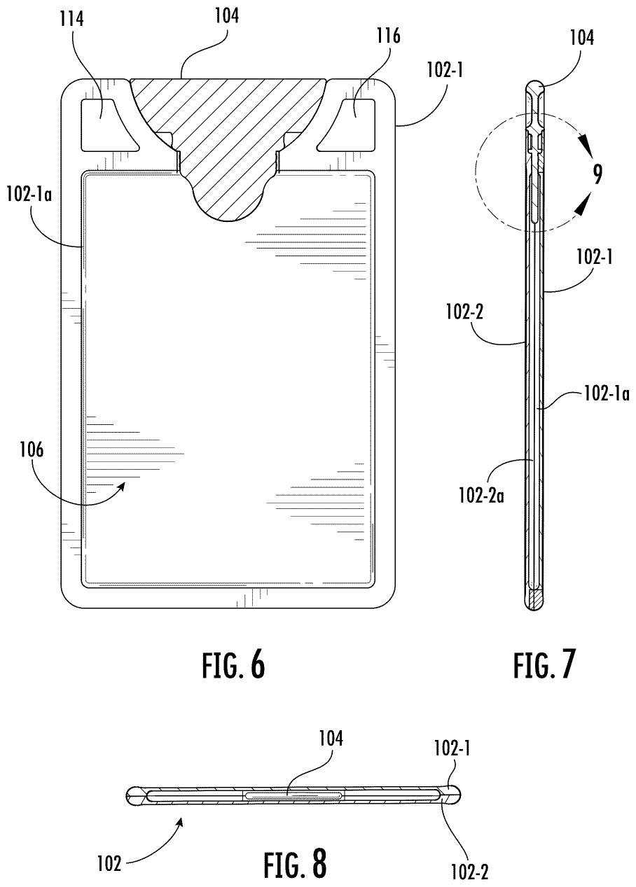

FIGS. 6-14, for example, illustrate side 102-1 and side 102-2 in detail. Side 102-1 includes a wall that incorporates a rectangular recessed portion 102-1a and side 102-2 incorporates an opposing rectangular recessed portion 102-2a that corresponds to the rectangular recessed portion 102-1a in a joined and sealed configuration. The rectangular recessed portions 102-1a and 102-2a together define cavity 106 for receiving and storing material or content. Sides 102-1 and 102-2 have indentations 102-3 and 102-4 that extend along and into a neck portion of hole 108 and cavity 106. That is, the neck portion of hole 108 is segment of body 102 that includes indentations 102-3, 102-4 along the surface thereof to receive projection ridges 104-4, 104-5 as described in more detail.

Applicator 104 has projection ridge 104-4, 104-5 that correspond (in shape and location) to indentations 102-3, 102-4 to seal applicator 104 within this hole 108 as described in more detail below. Sides 102-1 and 102-2 are shown as equal halves of body 102 that may be joined using ultrasonic welding, adhesive, laser welding or any method known to those skilled in the art. For ultrasonic welding, changes to the jointing surface and geometry may need to be made as known to those skilled in the art. In other alternatives, the sides may be configured as unequal halves.

Sides 102-1 and 102-2 are configured or constructed for flexibility (material) to enable a user to squeeze and elastically deform the walls of sides 102-1 and 102-2, thereby causing the content/material to be applied to applicator 104 as described in more detail below. In this example, the outline or shoulder of sides 102-1 and 102-2 around cavity 106 is configured to have greater rigidity than the center (walls) of sides 102-1 and 102-2. In this respect, the shoulder functions to prevent undesired deformity from forces exerted upon sides 102-1 and 102-2 when device 100 is inside a wallet, purse or pocket for example. That is, construction ultimately prevents the sides 102-1 and 102-2 from being squeezed and elastically deformed when the user does not desire to move material to the distal section 104-1 for application. Thus, leakage is avoided in these circumstances.

If a sticker is to be used as a labeling method or identification on either or both of walls 102-1 and 102-2 (on the side which the user touches to squeeze and deform the walls of sides 102-1 and 102-2), a corresponding indent should be incorporated into the walls 102-1 and 102-2 to ensure that the sticker does not exceed the thickness of the outline or shoulder described above.

Both sides 102-1 and 102-2 may be manufactured using injection molding and are duplicates (equal halves) of one another in this example as indicated above. In yet another alternative as indicated above, body 102 may be manufactured using blow molding as a singular integral structure with sides 102-1 and 102-2 defining a cavity extruded as known to those skilled in the art. Alternatively, body 102 may be manufactured as multiple components including two rectangular plates and a rectangular frame with indented beveled edges to receive the two rectangular plates. In this alternative example, the plastic sheets are attached using adhesive, heat staking, or another joining method to create the container body 102. The sheets would likely be stamped out of plastic sheets while the outline of the frame and the applicator are injection molded.

Applicator 104 is configured to fit into hole 108 and cavity 106 of body 102 and function as a sealing mechanism for the container body 102 to prevent material leakage from cavity 106 of body 102. Applicator 104 also importantly functions as a facilitator to release and remove material from cavity 106 and apply the material to a user's skin. Applicator 104 includes distal section 104-1, mid-section 104-2 and proximal section 104-3. Distal section 104-1 is configured or sized to fit, at least partially, within cavity 106 with sufficient gap 106-1 (of cavity 106) between the applicator distal section 104-1 (or portion thereof) and the inner walls of the sides 102-1 and 102-2 to enable sufficient material to flow around distal section 104-1, particularly when a user squeezes and deforms the outer wall of sides 102-1 and 102-2. Distal section 104-1 may also be referred to as a tongue herein. In the example shown, distal section 104-1 is configured in the shape of a half circular, end wall or tab.

In addition, distal section 104-1 is configured with a consistent thickness but with a width that varies (decreases toward the tip). The width and thickness of distal section 104-1 is less than the width and thickness of the neck portion of hole 108 to enable proper insertion. The width of distal section 104-1 should be less than width of the neck portion of hole 108 to avoid scrappage between distal section 104-1 and the entrance of hole 108. (Scrappage—when distal section 104-1 comes in contact with the neck portion of the hole and material is transferred from distal section 104-1 to the entrance of the neck portion of hole 108 of the body 102.) Other shapes, widths and thicknesses however may be used as known to those skilled in the art to achieved desires results. That said, distal section 104-1 is configured in a shape to properly apply the material to the skin of a user. Distal section 104-1 is configured to retrieve a thin layer on it when removed from 108 in body 102 and subsequently apply this layer of material to a user's skin.

In this respect, the greater the surface area of distal section 104-1, the greater the material will be removed from cavity 106 of body 102 when applicator 104 is removed. Distal section 104-1 is configured in such a way that once a user applies the material on the distal section 104-1 to the desired user location, minimal material will remain on distal section 104-1. The remaining material after use is subject to being scraped off distal section 104-1 when re-inserted into hole 108 of body 102. Thus, to minimize contents scraped off the distal section 104-1, the distal section 104-1 has been constructed to retain only enough material on it after its removal from hole 108 for one application. A significant decrease in distal section 104-1 surface area would result in not enough of material on the distal section 104-1 being removed from body 102 for a full application and a significant increase in surface area would result in increased leftover material on distal section 104-1 after application thus leading to extra material potentially scraped off distal section 104-1 when being re-inserted into body hole 108. The curvature of distal section 104-1 is sufficient that it guides applicator 104 into hole 108 and automatically centers applicator 104 into hole 108. As an example, application, if the material is lip balm, the user will rub distal section 104-1 of the applicator against their lips to transfer the material from the distal section 104-1 to their lips.

The neck of body hole 108 in which applicator 104 is inserted should have a thickness similar to the thickness of distal section 104-1 of applicator 104. This is because having a larger neck portion of hole 108 relative to the thickness of distal section 104-1 of applicator, the greater amount of material will be removed from cavity 102-6 onto distal section 104-1 when applicator 104 is removed. This then leads to excess material left over on distal section 104-1. This increases the scrappage in the same way as distal section 104-1 surface area described above.

Mid-section 104-2 includes dual projection ridges 104-4 and 104-5 that extend outwardly. Projection ridges 104-4, 104-5 are annular (partially) in shape in this example but could be any shape known to those skilled in the art. Projection ridges 104-4 and 104-5 correspond in shape and location to indentations 102-3 and 102-4 along the inside the neck portion of hole 108 of body 102 (when applicator 104 is fully seated in body 102). Projection ridges 104-4 and 104-5 provide a seal between the body hole 108 and applicator 104 to prevent leakage. If applicator 104 is a more flexible material than body 102, applicator 104 can flex into the body hole indentations 102-3 and 102-4 making a better seal. Dual projection ridges 104-4 and 104-5 provide tactile confirmation to the user that the applicator is fully seated into body 102. Applicator 104 is press fit into body 102.

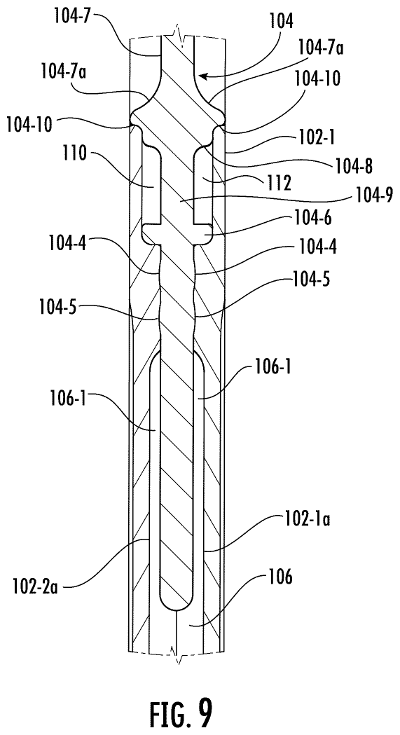

In addition, mid-section 104-2 further includes stopper seal 104-6 that is configured as an outwardly extending ledge that functions as stopper and seal when applicator 104 is fully inserted and seated within hole 108 of body 102. FIG. 9 illustrates this well. When applicator is fully seated in body 108, the top of proximal section 104-3 is flush with body 102 fully in this example. In this respect, the top of proximal section 104-3 is flush along top of body 102 (frame of body 102 that defines holes 114, 116 described hereinbelow). In this configuration, device 100 may easily fit within a wallet or purse sleeve or sleeve of a mobile device as described herein without interfering with closure or other contents in the wallet or iPhone.

Also, mid-section 104-2 includes a lower indented ledge 104-8 and upper indented ledge 104-10 on each side of applicator 104 in this example. Upper indented ledges 104-10 (one on each side of applicator 104) extends outwardly for engaging or abutting against the edges of sides 102-1 and 102-2 that define the opening and hole 108 when applicator 104 is fully inserted and seated within hole 108 of body 102. Upper indented ledges 104-10 are positioned just below the grasping part of proximal section 104-3 (bottom of lip 104-7a) and subsequently followed by lower indented ledges 104-8 that extend into the opening and hole 108 when applicator 104 is fully inserted and seated within hole 108 of body 102. Upper and lower indented ledges 104-10 and 104-8 function as a seal between the edges of the sides 102-1 and 102-2 that define the opening to hole 108. Both upper and lower indented ledges 104-10 and 104-8 are similar in shape to fillet corners as known to those skilled in art. Lower indented ledge 104-8 leads to carveout 104-9 which extends between ledge 104-8 and stopper seal 104-6. Carveout 104-9 extends generally perpendicularly downward from indented ledge 104-8. Carveout 104-9 is essentially sufficiently carved out of mid-section 104-2 to enable capture volume as described hereinbelow.

Proximal section 104-3 includes a grasping part that includes lip 104-7a to enable a user to grasp applicator 104. Lip 104-7a extends around an indented portion 104-7 of proximal section 104-3.

As described above, stopper seal 104-6 extends just below carveout 104-9. Stopper seal 104-6 is abutted against a ledge deeper within hole 108 when applicator 104 is seated within body 102. Ledges 104-8, carveout 104-9 and stopper seal 104-6 define leakage capture areas or zones 110, 112 between applicator 104 and body 102. Note that in this device 100, as shown in FIG. 9 for example, two numerals (110,112) are used to show the zones 110, 112 for reference purposes, but in actuality, ledges 104-8, carveout 104-9 and stopper seal 104-6 actually define a single volumetric cavity that wraps around applicator 104 in this example. (However, in other examples, it may in fact define to volumetric cavities on each side.) These zones or areas are used to capture any material that may leak from cavity 106 or is scrapped off the applicator's distal section 104-1 by the entrance of the neck portion of hole 108 when applicator 104 is inserted into body 102 after use. Lip 104-7a may be high friction material to enable a user to grasp it. Indented portion 104-7 may be made of a texture surface and/or high friction surface to facilitate grasping. Leakage and scrappage is minimized by the features described hereinabove. With the use of walls of sides 102-1 and 102-2 on body 102, leakage capture zones (volume) 110, 112 are formed so that any material leaked or scrapped-off is caught, thereby preventing the material from escaping outside of body 102 where it may stain a user's wallet and possibly destroy its contents. That is, capture zones 110, 112 are formed by lower ledge 104-8, carveout 104-9, stopper seal 104-6 and sides 102-1 and 102-2.

In this example, body 102 as formed include holes 114, 116 that maybe make it easier to remove body 102 from a user's wallet since it provides a spot to grasp using fingers. In addition, the holes may be used on a keychain or hook for example.

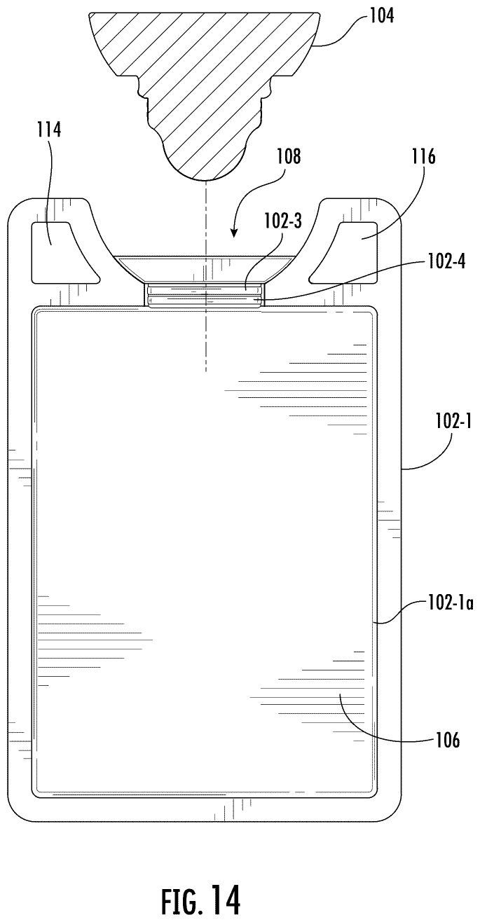

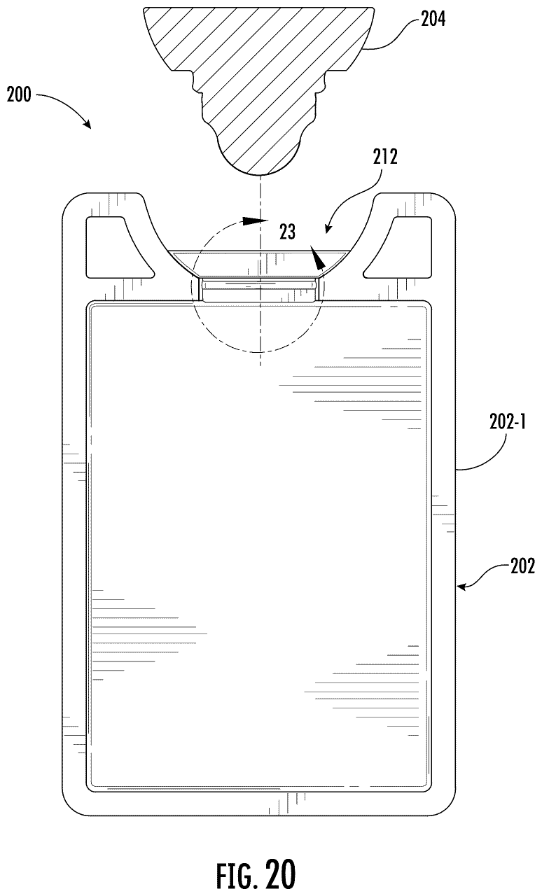

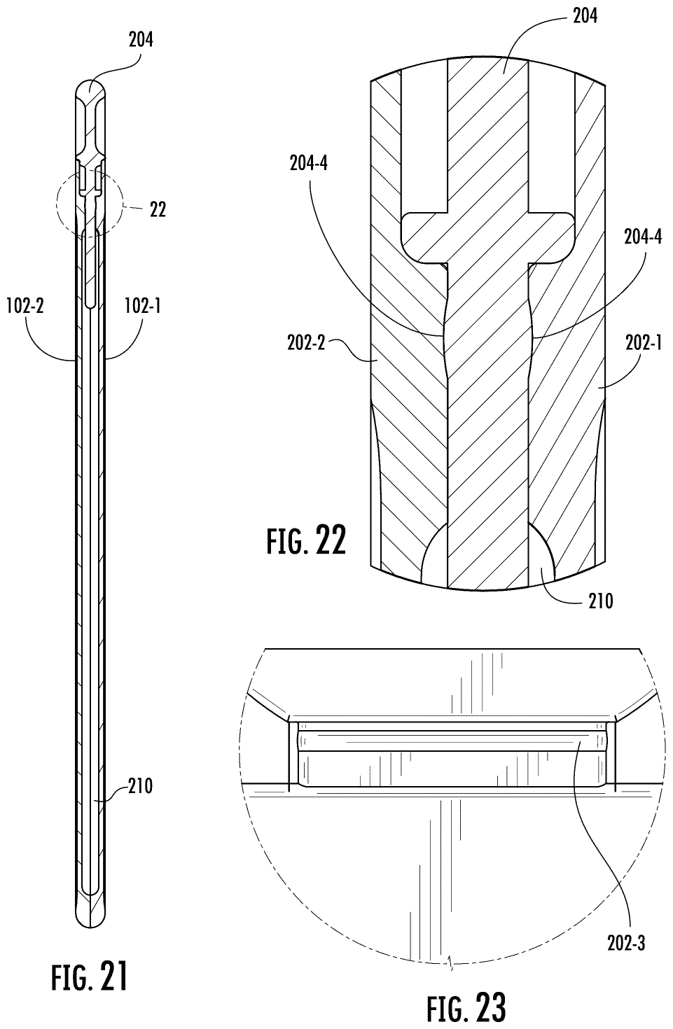

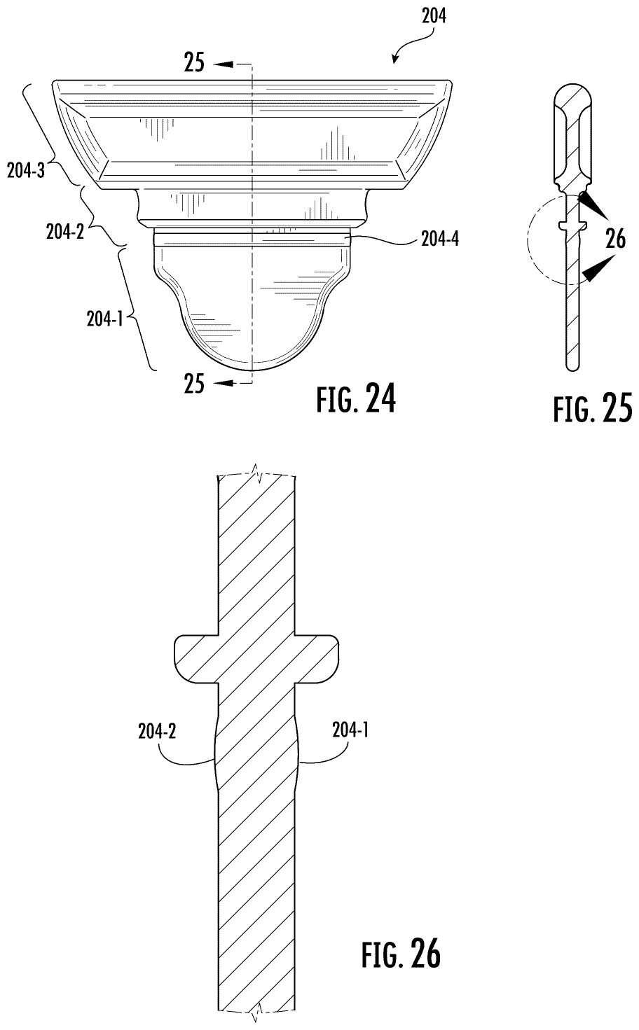

FIG. 20 depicts a front cross-sectional view of second example device 200 for storing and applying material to a skin of a user for medical and/or cosmetic purposes in an exploded configuration. FIGS. 21-26 depict device 200 in various views. This second example device 200 (and view thereof) is similar to example device in FIG. 14, but the second example device 200 has applicator 204 and body 202 with a single projection ridge and corresponding indentations, respectively.

Specifically, body 202 includes side 202-1 and side 202-2 similar to the example above. Sides 202-1 and 202-2 have indentations 202-3 that extend into hole 212 (neck portion) of body 202. Applicator 104 has the same three sections: distal section 204-1, mid-section 204-2 and proximal section 204-3. Mid-section 204-2 is similar to the same above, but it now includes only one projection ridge 204-4 that wraps around applicator 204 that correspond in size and shape of indentations 202-3 (on each side). A single ridge projection is the same as the dual ridge described above but with one ridge on both the applicator and body hole. All other aspects remain the same regarding material, tactile confirmation, and force. One advantage is that with single ridge projection the user knows that he/she has fully seated applicator 204 into body 202 making the seal after a single click.

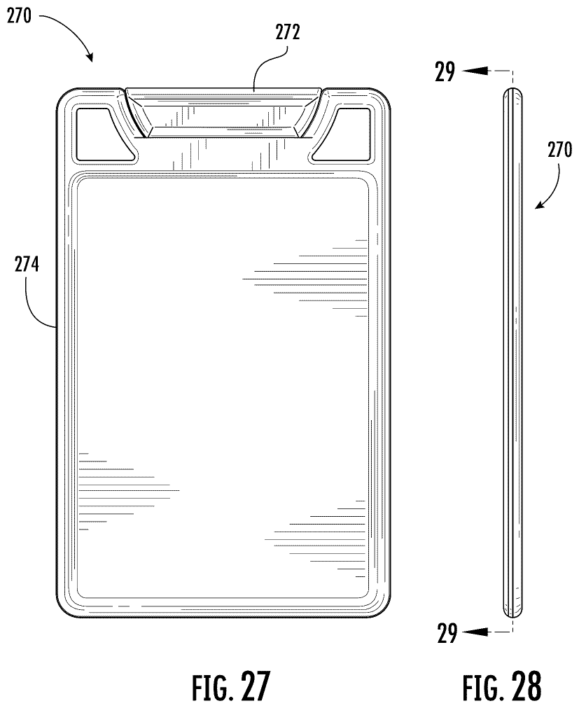

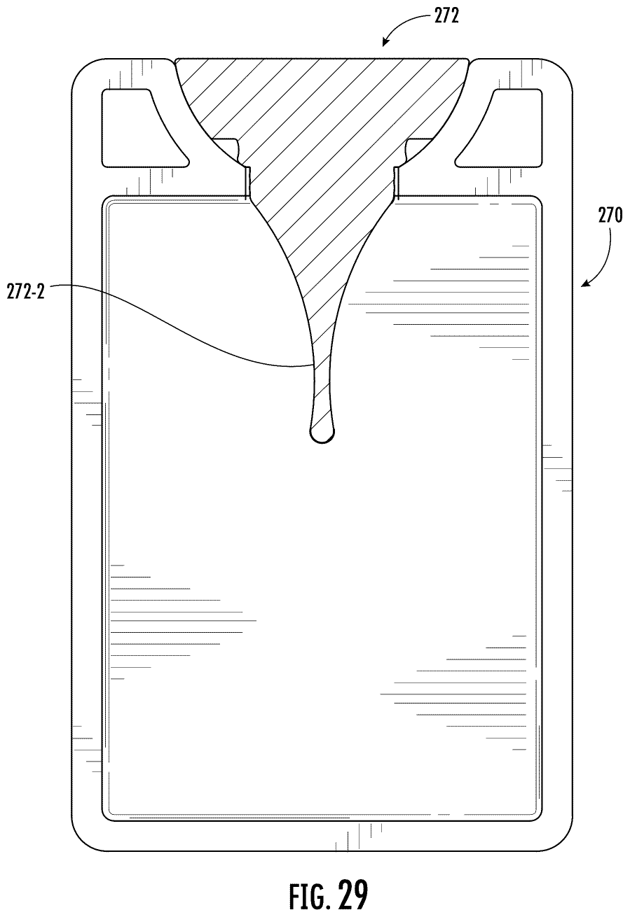

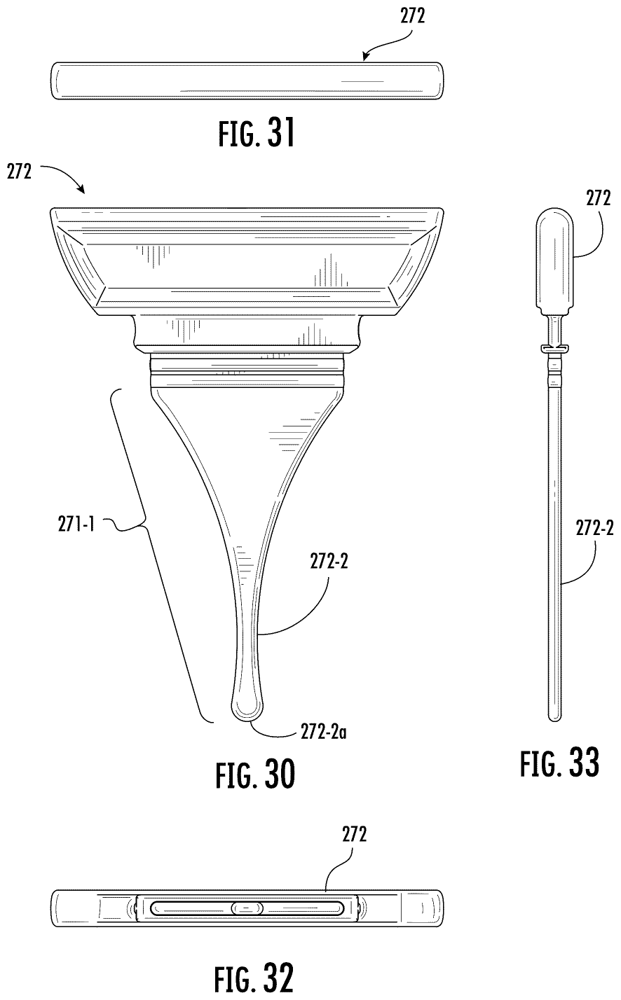

FIG. 27 depicts a plan view of third example device 270 for storing and applying material to a skin of a user for medical and/or cosmetic purposes. FIGS. 27-33 depict device 270 in various views. Device 270 is configured as applicator 272 in a different-shape as other example devices above. The same body 274 is used as in the first examples device above. Therefore, details of body 274 will not be described here. However, applicator 274 includes a distal section 272-1 (tongue) that is formed into narrow tip 272-2. Specifically, distal section 272-2 tapers or narrows inwardly in a circular arc down toward its distal end 272-2a. In this example, however, distal end 272-2a slightly widens at the distal end 272-2a as the end of the inward arc. This shape would allow for a more precise application of the material, or one with fuzz on it like the tips of lip gloss applicators. The length of distal section 272-2 can also increase as long as there is not an excess amount of material on the tongue after an application that can potentially scrape off. Other aspects of applicator 272 and body 275 are similar to or the same as applicator 104 and body 102 above including, but not limited to dual ridge projections and indentations.

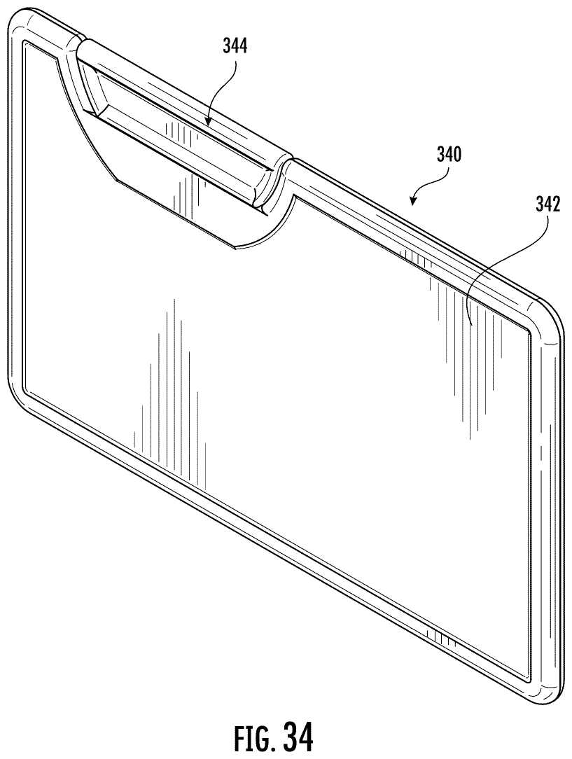

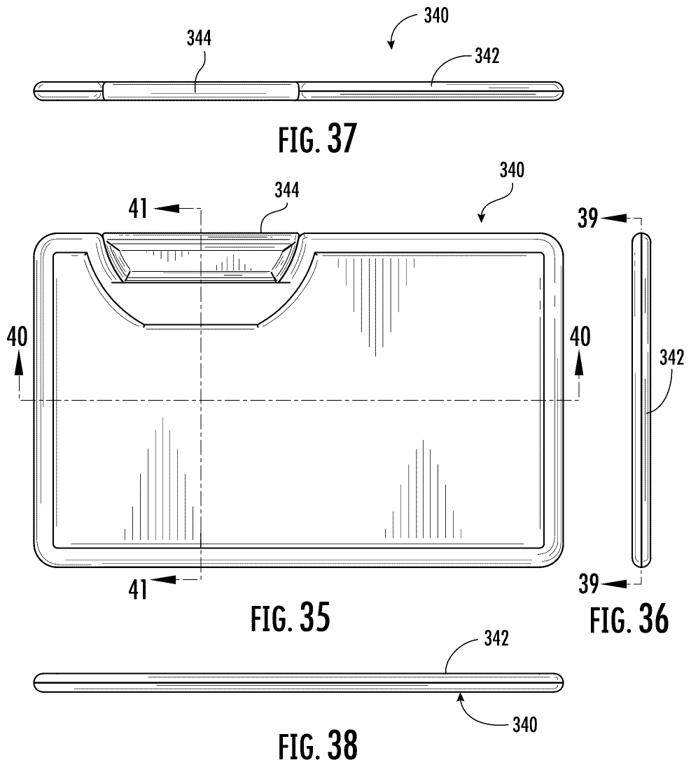

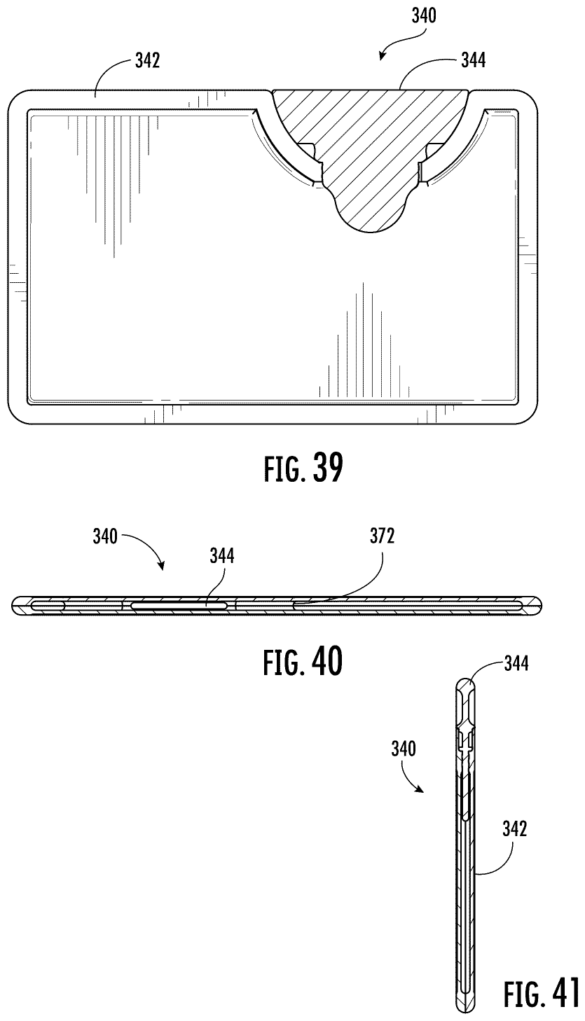

FIG. 34 depicts a perspective view of fourth example device 340 for storing and applying material to a skin of a user for medical and/or cosmetic purposes. FIGS. 35-41 depict additional (various) views of device 340. In this example, device 340 is the same as example device 100 except that the location of the hole for receiving applicator 344 is in a different position. In this example, the hole is positioned along the length of the body 342 toward the end thereof. Applicator 344 will be removed and reinserted in this position as shown. There are no key chain holes 114 and 116 in this example device 340.

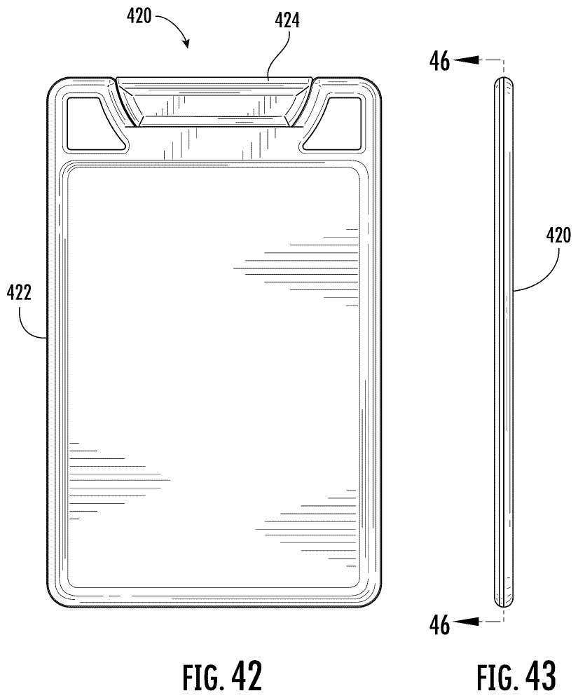

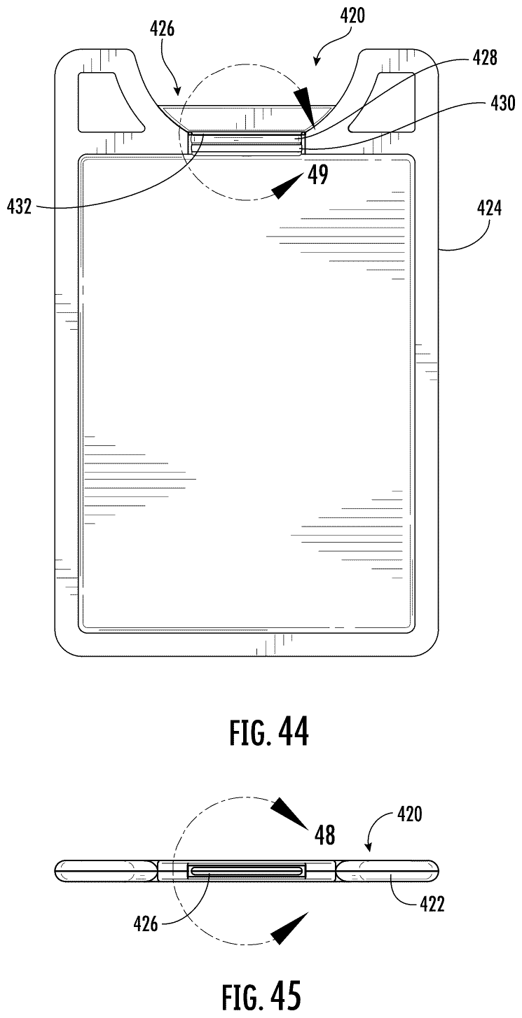

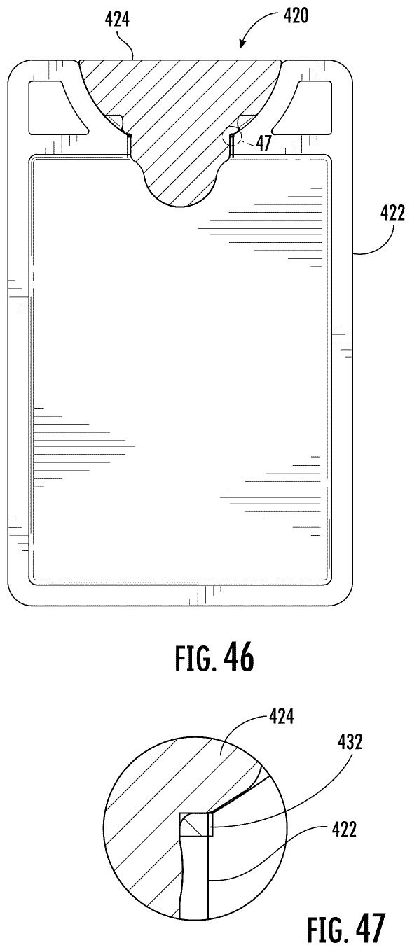

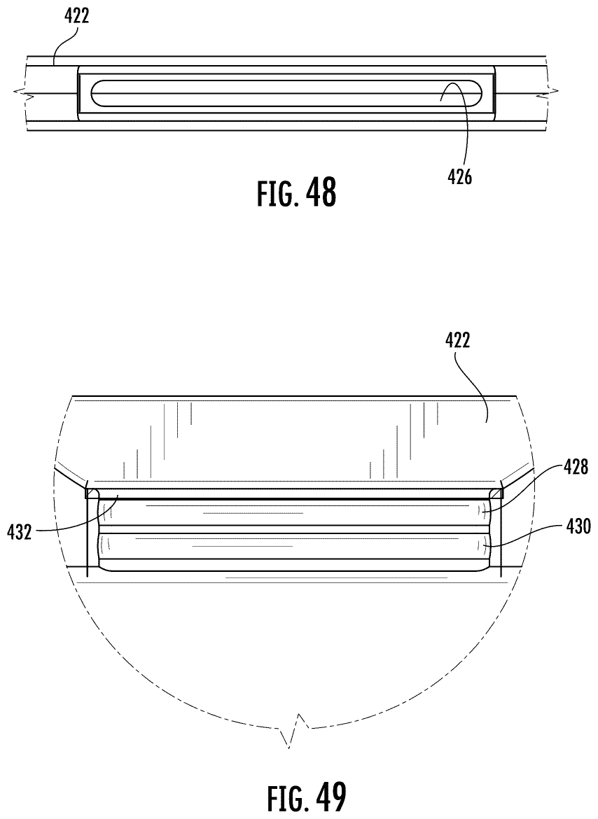

FIG. 42 depicts a plan view of fifth example device 420 for storing and applying material to a skin of a user for medical and/or cosmetic purposes. FIGS. 43-49 depict various views of device 420. This example device 420 is quite similar to device 100 above. In this example device 420, device 420 includes a body 422 and applicator 424. Body 422 includes hole 426 with dual projection ridges 428, 430, but in example device 424, rubber seal 432 is incorporated within the entryway of the neck port of hole 426 along the edge above projection ridge 428. Seal 432 is used at a point of sealing hole 426 when applicator 424 is fully inserted and seated within body 422.

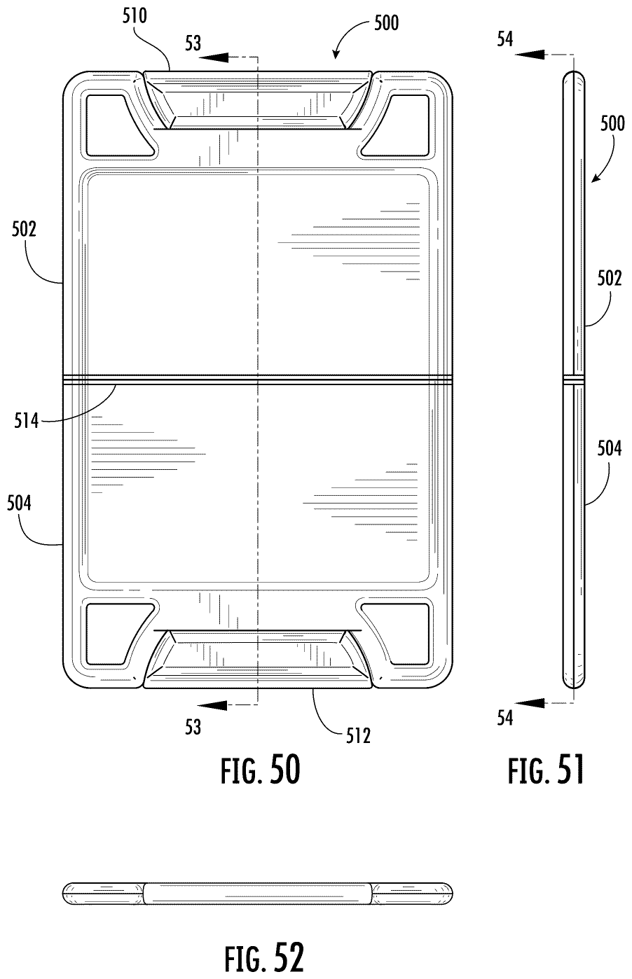

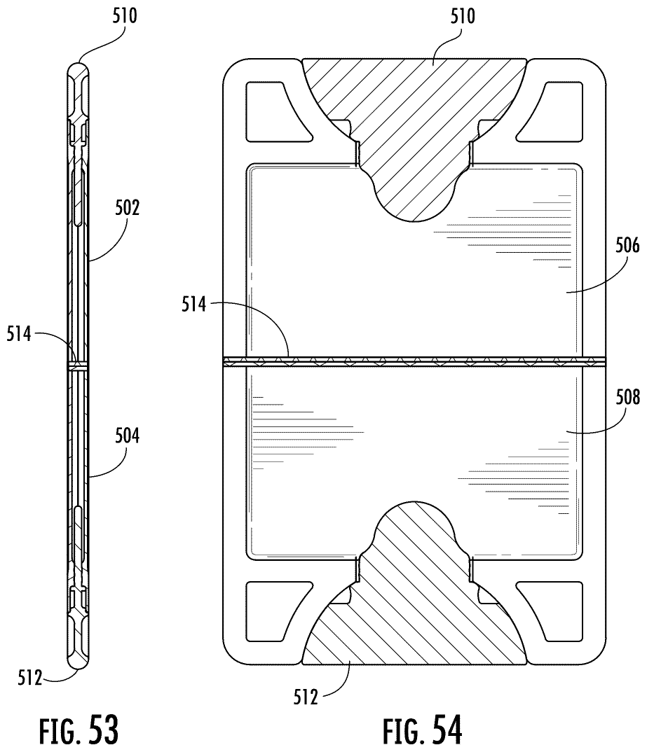

FIG. 50 depicts a plan view of sixth example device 500 for storing and applying material to a skin of a user for medical and/or cosmetic purposes. FIGS. 51-54 depict various views of device 500. Example device 500 is similar to device 100 except it is a dual applicator device with dual cavities. Specifically, device 500 effectively one body split into two sections 502 and 504, each of which has a cavity 506, 508 for material and an applicator 510, 512. This is similar to that in device 100. Body includes an internal wall 514 separating the two sections 510, 512 and cavities 506, 508. The advantage of having two cavities is that two different types of materials can be stored and applied of one body of device 500. For example, one side may have lip balm, while the other may have lip gloss.

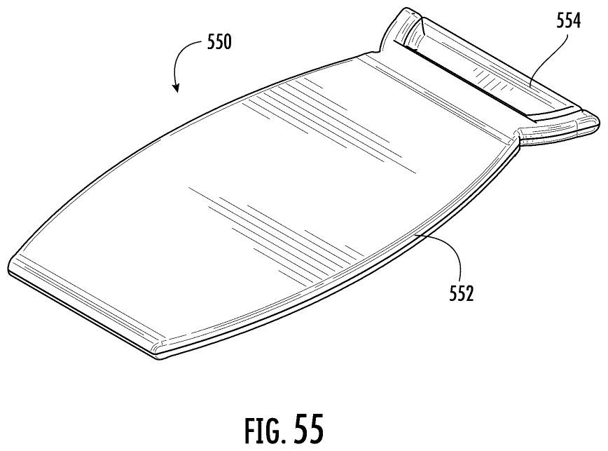

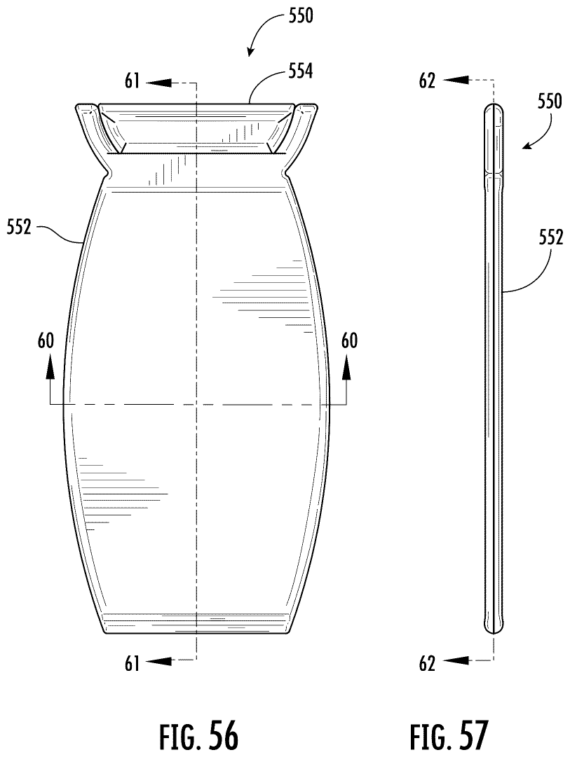

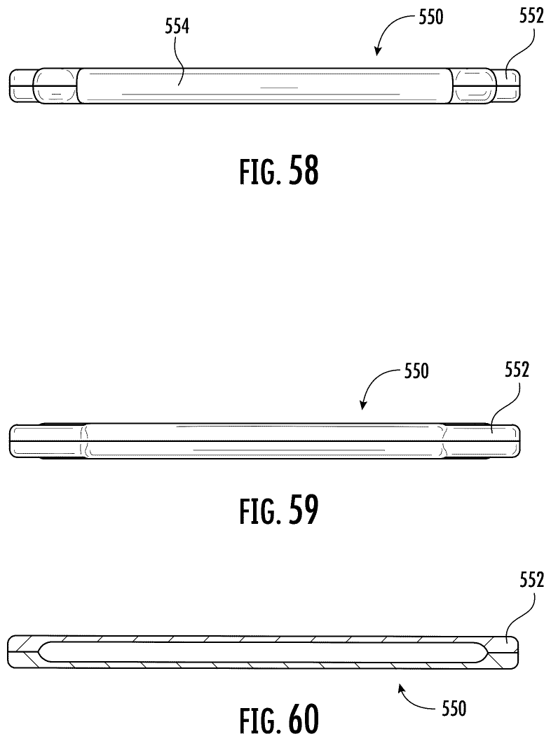

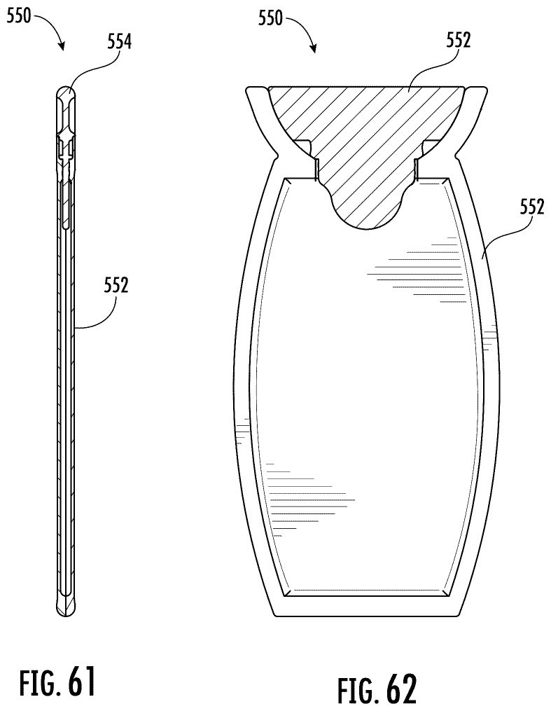

FIG. 55 depicts a perspective view of seventh example device 550 for storing and applying material to a skin of a user for medical and/or cosmetic purposes. FIGS. 56-62 depict various views of device 550. Example device 550 is similar to the other example devices described herein but device 550 is configured as an oval shaped device. Device 550 includes body 552 and applicator 554.

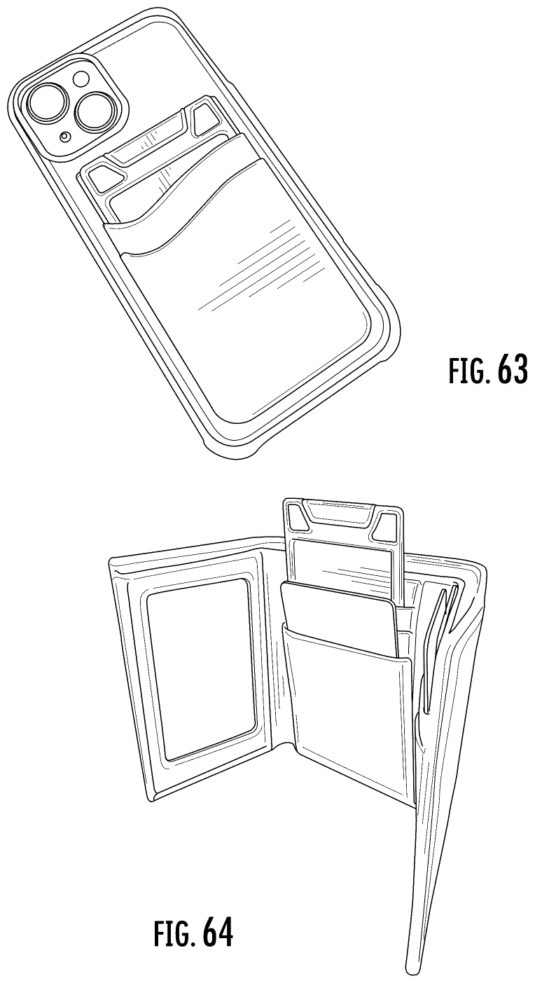

FIG. 63 depicts a perspective view of the example device in FIG. 1 in a practical application. Specifically, device is inserted into a sleeve attached to an iPhone. FIG. 64 depicts a perspective view of the example device in FIG. 1 in another practical application. Specifically, the device is partially inserted into a wallet.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A device for storing and applying material to a skin of a user for medical and/or cosmetic purposes, the device comprising:
a body including first and second sides that define (1) a cavity that functions as a reservoir for storing the material and (2) a hole that communicates with the cavity; and
an applicator configured to be inserted into and removed from the hole of the body, the applicator including:
(1) a first section configured to be grasped by the user for applicator removal from and insertion into the hole of the body; and
(2) a second section for accumulating material within the cavity of the body and for subsequently applying the material to the skin of the user.

2. The device of claim 1 wherein the applicator further includes a third section between the first and second sections, the third section comprises (1) a seal that is configured as a ledge that extends outwardly with respect to the first section, the seal functions as a seal between the applicator and the body when applicator is fully inserted and seated within the hole of body.

3. The device of claim 2 wherein the third section further comprises first and second indented ledges for engaging first and second edges of the first and second sides, respectively, that define an opening to the hole.

4. The device of claim 2 where the third section further comprises an indented ledge that extends into the hole and a carveout extending from the indented ledge, wherein the sides of the body, the indented ledge, the carveout and seal together form a capture zone between the applicator and the body when the applicator is fully inserted and seated within the hole, thereby preventing leakage of material outside of the body.

5. The device of claim 1 wherein the applicator includes a third section having a first that extends in an outward direction away from the first section, the ridge is configured to secure the applicator within the body when fully seated therein.

6. The device of claim 5 wherein the body includes at least indentation to receive the first ridge of the third section to secure the applicator within the body when seated therein.

7. The device of claim 1 wherein the first section includes a lip configured to facilitate grasping.

8. The device of claim 5 wherein the third section includes a second ridge adjacent the first ridge that extends outwardly and that is configured to secure the applicator within the body when fully seated therein.

9. The device of claim 1 wherein the first section of the applicator is circular at the distal end thereof.

10. The device of claim 1 wherein the distal section is configured with sufficient surface area to retain enough material from the cavity after the applicator is removed from the body so that once the user applies the material on the distal section to a desired user location, minimal material will remain on distal section that may be subject to being scraped off when the applicator is re-inserted into the hole of the body.

11. The device of claim 1 further comprising a rubber seal within the hole to facilitate sealing contact between the applicator and the body.

12. The device of claim 1 wherein the body includes a second cavity that is separated from the cavity by a wall and a second hole that communicates with the second cavity.

13. The device of claim 12 further including a second applicator configured to fit within the second hole.

14. The device of claim 1 wherein the body includes a first side and a second side that together device the cavity and hole.

15. The device of claim 1 wherein the material is lip balm, lip gloss or petroleum jelly.

16. The device of claim 1 wherein the skin comprises lips of the user.

17. The device of claim 1 wherein the body is configured as a single integral structure that includes the first and second sides, a two-piece structure that includes the first and second sides or a three piece structure that includes the first and second sides that are combined to form the body.

18. The device of claim 1 wherein the first and second side are deformable.

19. The device of claim 1 wherein the body includes a hole for a keychain.

20. A device for storing and applying material to a skin of a user for medical and/or cosmetic purposes, the device configured to fit in a sleeve sized to fit a credit card, the device comprising:
a body including first and second sides that define (1) a cavity that functions as a reservoir for storing the material, (2) a hole that communicates with the cavity and (3) a first indentation within the hole of the body; and
an applicator configured to be inserted into and removed from the hole of the body, the applicator including:
(1) a proximal section configured to be grasped by the user for applicator removal from and insertion into the hole of the body;
(2) a distal section for accumulating material within the cavity of the body and for subsequently applying the material to the skin of the user; and
(3) a mid-section between the proximal section and distal section having a first ridge that extends outwardly and that is configured to fit within the first indentation to secure the applicator within the body when seated therein.

21. The device of claim 20 wherein the mid-section between the first and second sections, the third section comprises (1) a seal that is configured as a ledge that extends outwardly with respect to the first section, the seal functions as a seal between the applicator and the body when applicator is fully inserted and seated within the hole of body.

22. The device of claim 21 wherein the mid-section further comprises (a) first and second upper indented ledges for engaging first and second edges of the first and second sides, respectively, that define an opening to the hole and (b) first and second lower indented ledges extend from upper indented ledge and (c) a carveout extending from the lower indented ledge.

23. The device of claim 21 wherein the mid-section further comprises (a) first and
second indented ledges that extends into the hole and (b) a carveout extending from the first and second lower indented ledges, wherein the sides of the body, the first and second lower indented ledges, the carveout and seal together form at least one capture zone between the applicator and the body when the applicator is fully inserted and seated within the hole, thereby preventing leakage of material outside of the body.

24. The device of claim 20 wherein the mid-section includes a second ridge that extends outwardly and the body includes a second indentation within the hole of the body to receive the second ridge to secure the applicator within the body when fully seated therein.

25. The device of claim 20 wherein the proximal section of the applicator is circular at the distal end thereof.

26. The device of claim 20 further comprising a rubber seal within the hole to facilitate sealing contact between the applicator and the body.

27. A device for storing and applying material to a skin of a user for medical and/or cosmetic purposes, the device configured to fit in a sleeve sized for a credit card, the device comprising:
a body including first and second sides that define (1) a cavity that functions as a reservoir for storing the material and (2) a hole that communicates with the cavity, the body including a first indentation within the hole of the body; and
an applicator configured to be inserted into and removed from the hole of the body, the applicator including:
(a) a first ridge that extends outwardly configured to fit within the indentation within the hole of the body and secure the applicator within the body when fully seated therein; and
(b) a tongue for accumulating material within the cavity of the body and for subsequently applying the material to the skin of the user.

28. The device of claim 27 wherein the applicator further includes (1) a seal that is configured as a ledge that extends outwardly with respect to the tongue, the seal functions as a seal between the applicator and the body when applicator is fully inserted and seated within the hole of body.

29. The device of claim 27 wherein the applicator further includes (a) first and second upper indented ledges for engaging first and second edges of the first and second sides, respectively, that define an opening to the hole and (b) first and second lower indented ledges extend from first and second upper indented ledges and (c) a carveout extending from the lower indented ledge.

30. The device of claim 27 wherein the applicator further mid-section further comprises (a) first and second indented ledges that extends into the hole and (b) a carveout extending from the first and second indented ledges, wherein the sides of the body, the first and second indented ledges, the carveout and seal together form at least one capture zone between the applicator and the body when the applicator is fully inserted and seated within the hole, thereby preventing leakage of material outside of the body.

31. The device of claim 27 wherein the body is configured as a single integral structure that includes the first and second sides, a two-piece structure that includes the first and second sides or a three piece structure that includes at least the first and second sides that are combined to form the body.
